(19) United States
(12) Patent Application Publication
(10) Pub. No.: US 2005/0089695 A1
(43) Pub. Date: Apr. 28, 2005

(54) Silane coated substrate

(76) Inventors: William A. Moffat, San Jose, CA (US); Boris C. Randazzo, Hollister, CA (US); Craig W. McCoy, San Jose, CA (US); Stuart V. Allen, Gilroy, CA (US)

Correspondence Address: MICHAEL A. GUTH, 2-2905 EAST CLIFF DRIVE, SANTA CRUZ, CA, 95062, US

(21) Appl. No.: 10/843,774

(22) Filed: May 11, 2004

Related U.S. Application Data
(63) Continuation-in-part of application No. 10/695,633, filed on Oct. 27, 2003.

(51) Int. Cl. B32B 25/20

(52) U.S. Cl. 428/429

(57) ABSTRACT

A silane coated substrate with a consistent surface energy across its surface. This consistent silane layer has a contact angle with a variation of less than +/−10 degrees as measured by a goniometer. The consistent silane layer also retains its consistency in moist environments. A silane layer with a minimum of defects.

### CROSS-REFERENCE TO RELATED APPLICATIONS

This application is a Continuation in Part of application Ser. No. 10/695,633 to Moffat, Randazzo, McCoy, and Allen, with a filing date of Oct. 27, 2003 which is herein incorporated by reference in its entirety.

### BACKGROUND

1. Field of the Invention

This invention relates generally to coated substrates, and more specifically to substrates coated with silanes.

2. Description of Related Art

The macroscopic properties of a surface can easily be characterized by observing the shape of liquid droplets on the material, which is a result of the free energy of the surface, as well as the free energy of the liquid. The force per unit length affecting the surface or interface is the interfacial tension γ, which is usually expressed in units of mN/m or dyn/cm. When a liquid does not completely wet a surface, it forms an angle θ, which is known as the contact angle and is measured with a goniometer. The contact angle is the angle formed between a substrate surface and the tangent line at the point of contact between a liquid droplet and the substrate surface.

The wetting ability of a liquid with respect to a solid surface can be characterized by measuring the contact angle between the liquid meniscus and the surface; a contact angle of less than 90 indicates that the substrate is readily wetted by the liquid, while an angle greater than 90 shows that the substrate will resist wetting. If the liquid wets the surface completely, the contact angle will be 0. In the opposite case, when there is not interaction between the surface and the liquid, the contact angle will be 180.

High energy substrates will be readily wettable by most liquids. In contrast, low energy substrates are only wettable by liquids whose own surface tension is low enough. Waterproofing of materials may involve the coating of the material with a relatively non-wettable material so that water breaks off instead of soaking in.

The printing industry is an example of a field where surface energies and contact angles are important considerations. It has long been recognized that the first step in obtaining good adhesion and print quality is to assure that the ink wets out on the substrate evenly. The primary forces involved are the surface tension of the ink and the surface energy of the film (substrate). In order for the liquid to sufficiently wet out on the surface of the substrate, the material has to have high enough surface energy, in relation to the surface tension of the liquid being applied. If the tension of the liquid is higher than the surface energy of the substrate, the molecules of the liquid would tend to cling together, forming a bead or drop.

Compounds are often added to either to the inks to alter their surface tension, or to the surface of the substrate to alter its surface energy, in order to deliver high quality printing. If there is too much wetting, the ink may spread out and not deliver resolute printing. On the other hand, if there is not enough wetting, the ink may bead up and run off. The paper that is used in many printing applications is viewed as having a certain surface energy. The variability in the surface energy of the paper, or surface to be printed, across the surface has an effect on the ability of the process to match the surface with an appropriately surface tensioned ink, and therefore has an effect on the resolution and the quality of the printing process.

A newer field of printing is the printing of DNA microarrays on glass slides. DNA microarrays are used in hybridization based assays including the measurement of comparative gene expression levels. The printing of DNA onto glass slides includes a process referred to as DNA immobilization. Oligonucleotides are often immobilized onto glass slides. A DNA microarray consists of different types of DNA strands printed onto different areas of the slide. The process of immobilizing DNA strands onto an area of the slide is analogous to the printing of an ink drop onto paper in the sense that surface energy of the substrate and the surface tension of the DNA laden liquid, which primarily determine the amount of wetting, effect the resolution that the process can attain. In addition to the DNA array chips now used, protein array chips may have many possible applications in the future.

A basic building block of many types of these chips is a substrate topped with an organic silane molecule monolayer. The substrate may consist of silicon or glass or other materials. Earlier processes resulted in silane layers which were inconsistent across their surface area, which was seen in variations in contact angle measurements across the surface area. Variation in the contact angle across a surface would be greater than +/−10.

Across the surface of a glass or silicon substrate are hydroxyl ions entrenched in the substrate itself. The hydrogen of the embedded hydroxyl ion extends away from the surface of the substrate. In a reactive process with silanes, such as silicon trimethyl, the Si of the silicon trimethyl group supplants the hydrogen of the embedded hydroxyl, resulting in a very strong bond to the substrate. This organic/inorganic bridge then allows for the immobilization of DNA or protein strands onto the substrate.

If the substrate has moisture on its surface, the Si of the silicon trimethyl group may instead supplant the hydrogen of a water molecule on the substrate surface. In contrast to the strong bond to the substrate achieved when the Si is attached to the oxygen atom of the hydroxyl ion, which is embedded in the substrate, there is no such strong bond when the hydrogen of the water molecule is supplanted. The silane layer formed in the presence of moisture on the substrate is therefore inconsistent, with some portions of the silane layer strongly bonded to the substrate while other portions are not. The portion of silane layer which is not strongly bonded to the substrate may not stay attached to the substrate. This loss usually occurs immediately, upon the first exposure to moisture, or during subsequent processing of the coated substrate.

A method and apparatus for forming a consistent silane layer without, or with a minimum of, moisture related defects is discussed in U.S. patent application Ser. No. 10/656,840, to Moffat and McCoy, with a filing date of Sep. 5, 2003, and is hereby incorporated by reference in its entirety.

Another use for forming a consistent silane layer with a minimum of defects is the prevention of diffusion of copper into layers such as dielectrics in fields such as semiconductor manufacturing. Silane may be used as a diffusion barrier between copper and other layers, such as dielectrics layers, during the copper deposition process, subsequent annealing processes, or other processes. The use of silane in this manner may allow the diffusion barrier layer to be significantly thinner. A consistent silane layer, even after significant exposure to moisture, allows for the creation of a thin copper diffusion barrier with less defects. Multiple silane layers, using either a single silane or different silanes, may also be used to reduce defects.

Prior silane coated substrates have had some serious drawbacks. Because the layer had numerous areas where the layer was bonded to water on the surface, the surface energy across the surface of a layer would vary, as the weakly bonded areas immediately degraded. This variation in the surface energy resulted in variations in the contact angle with a given liquid, and had a negative impact upon the consistency and resolution of DNA microarray printing. As higher densities of microarrays were sought, the inconsistency of the silane layer, because of these defects, becomes a limitation. Prior silane coated substrates have variations in contact angle measurements across their surface area of +/−10 and greater.

A second serious drawback of prior silane coated substrates is that the inconsistent silane layer adds uncertainty to the results of the assays done using the microarrays. If the silane layer is inconsistent, then the density of DNA strands per unit area of the substrate after immobilization would also be inconsistent. This condition can interfere with the accuracy of data from the assays performed.

A drawback of prior copper diffusion barrier layers used in semiconductor and other manufacturing has been the thickness of such layers. The use of silane in applications such as diffusion barrier layers allows for a thinner barrier layer, allowing for the more efficient use of space. Defects in a silane layer used a diffusion barrier might lead to faults in a semiconductor, thus a silane layer with a minimum of defects enhances is favored over other methods. In addition, the use of a vapor process to deposit silane onto a porous dielectric layer allows for penetration into pores and further limits any shortcomings in the prior art methods.

What is needed is a substrate with a consistent silane layer and a consistent surface energy across its surface. What is also called for is a substrate with a consistent silane layer that remains consistent after exposure to moisture.

### SUMMARY

A silane coated substrate with a consistent surface energy across its surface. This consistent silane layer has a contact angle with a variation of less than +/−10 degrees as measured by a goniometer. The consistent silane layer also retains its consistency in moist environments. A silane layer with a minimum of defects which may be used a diffusion barrier layer.

### BRIEF DESCRIPTION OF THE DRAWINGS

FIG. 1 is a representative cross-section of a coated substrate.

FIG. 2 illustrates a hydroxyl ion and water on a substrate surface.

FIG. 3 illustrates water droplets and contact angles on a substrate surface.

FIG. 4 shows two figurative representations of hydroxylated substrates.

FIG. 5 illustrates a molecule bonded to a substrate.

FIG. 6 illustrates a substrate coated with a silane monolayer.

FIG. 7 is a top view of a coated substrate.

FIG. 8 is a side view of a droplet on a substrate surface.

FIG. 9 is a cross sectional view of a substrate utilizing a barrier layer.

FIG. 10 is a cross sectional view of a substrate utilizing a plurality of barrier layers.

### DETAILED DESCRIPTION

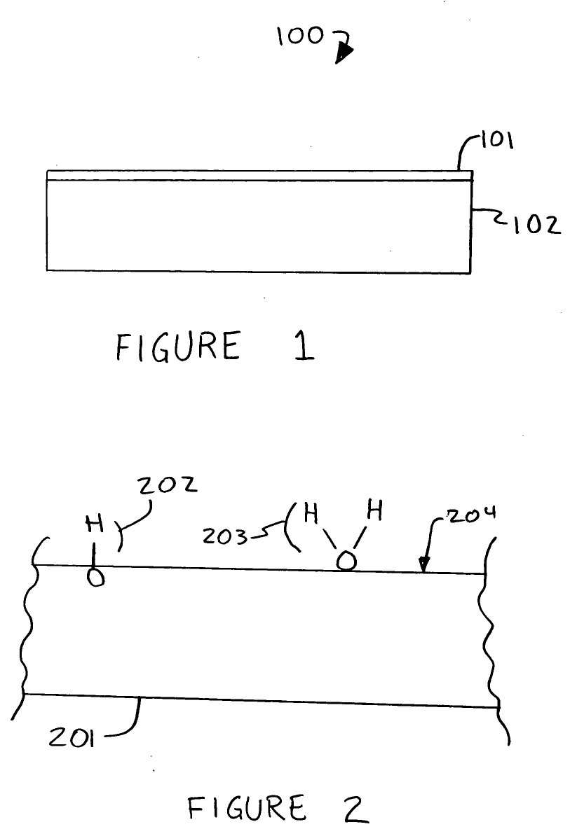

FIG. 1 illustrates a coated substrate 100 according to some embodiments of the present invention. The substrate 102 is glass in some embodiments of the present invention. The substrate 102 may be of a variety of glass types, including soda lime glass, borosilicate glass, or pure silica. In other embodiments, substrate 102 may be silicon. Layer 101 is a silane layer. Silane layer 101 may be comprised of amino silanes, epoxy silanes, and/or mercapto silanes in some embodiments. Silane layer 101 may be 3-aminopropyltrimethoxysilane in some embodiments. Silane layer 101 may be 3-3-glycidoxypropyltrimethoxysilane in some embodiments.

FIG. 2 illustrates a hydroxyl ion 202 embedded in a substrate 201, as would be seen in the case of a hydroxylated substrate. A water molecule 203 is seen on the surface 204 of the substrate 201. The substrate 201 may be glass, silicon, a dielectric coated substrate, or other surface in some embodiments.

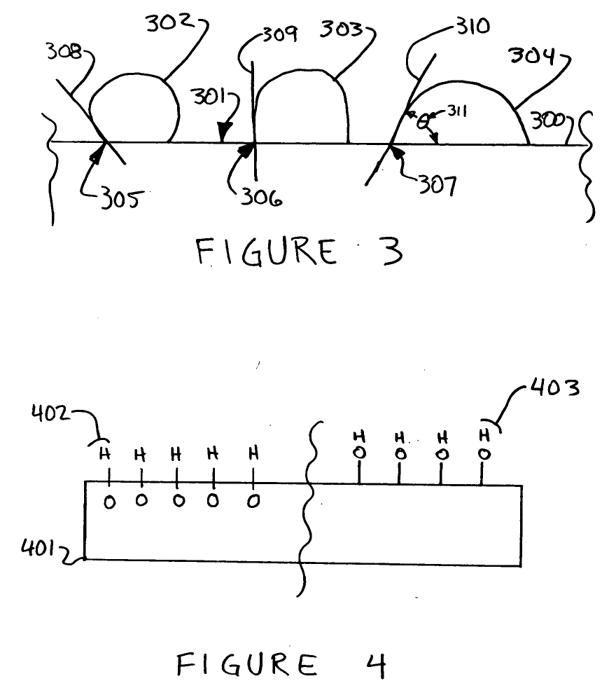

FIG. 3 depicts illustrations of droplets 302, 303, 304 on the surface 301 of a substrate 300. The droplet 302 with the least amount of wetting has the largest contact angle. The contact angle of the droplet 302 is measured as the angle from the substrate surface to the tangent line 308 constructed from the exterior contact point 305. The droplet 304 shown with the most amount of wetting has the smallest contact angle 311, constructed by creating a tangent line 310 at the contact point 307. Droplet 303 has a 90 degree contact angle as determined by the angle of the tangent line 309 at the contact point 306. A surface with a consistent surface energy will have a consistent contact angle around the periphery of the droplet, as well as having a consistent contact angle for droplets at different locations on the surface.

FIG. 4 shows two separate figurative representations of a hydroxylated substrate 401. Hydroxyl ions 402, 403 may be represented with either method of illustration.

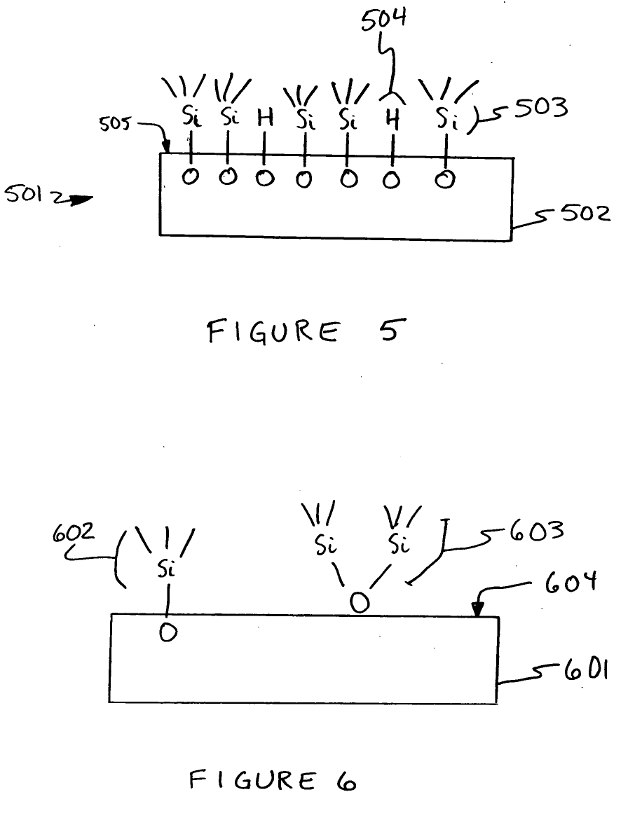

FIG. 5 illustrates a coated substrate 501 according to one embodiment of the present invention. The substrate 502 has had many of the hydroxyl ions 504 embedded in its surface 505 reacted with HMDS such that silicon trimethyl 503 (methyl groups not shown) has bonded to the substrate 502. The density of reacted hydroxyl ions on the surface is consistent across the surface 505 of the substrate 502. This density may be altered by the pressure of the reactive process and the time duration of the reactive process in some embodiments. The surface energy of the embodiment 501 of FIG. 5 remains consistent after significant exposure to moisture. The goniometer angle measured across various points on the surface of coated substrate 501 remains consistent after significant exposure to moisture. As seen in FIG. 6, silicon trimethyl has bonded to water on the surface 604 of the substrate 601. The product of this reaction 603 sits on top of the surface 604 of the substrate 601 and is not strongly bonded to the substrate 601. In contrast, the silicon trimethyl 602 that has reacted with an embedded hydroxyl ion is strongly bonded to the substrate 601.

The silane layers according to some embodiments of the present invention have consistent thickness across the surface of the substrate. The silane layer may thicken itself with more processing time as additional silane molecules adhere to silane molecules that have adhered to the substrate in a self-assembling layer.

When the chemical reactive process utilizes substrates that have not been sufficiently dehydrated, the silane layer is formed bonding to both hydroxyl ions and to water on the surface of the substrate. These prior silane layers would thus lose consistency immediately as the weakly bonded portion of the layer was lost. This inconsistency was exacerbated during further processing as the substrate was exposed to moisture and more of the poorly adhered area was lost.

A layer that has originally been formed to have a consistent density of silane across it surface will have a consistent surface energy only if the layer remains stable after processing. A stable silane layer will have a consistent surface energy as measured by a goniometer. Different process parameters result in different surface energies. The stability of the silane layer will be demonstrated both by consistent measurements at different positions on the surface and by consistent contact angles around the meniscus of a single droplet used in contact angle measurement. The consistency of the layer will remain in the presence of moisture and throughout subsequent processing.

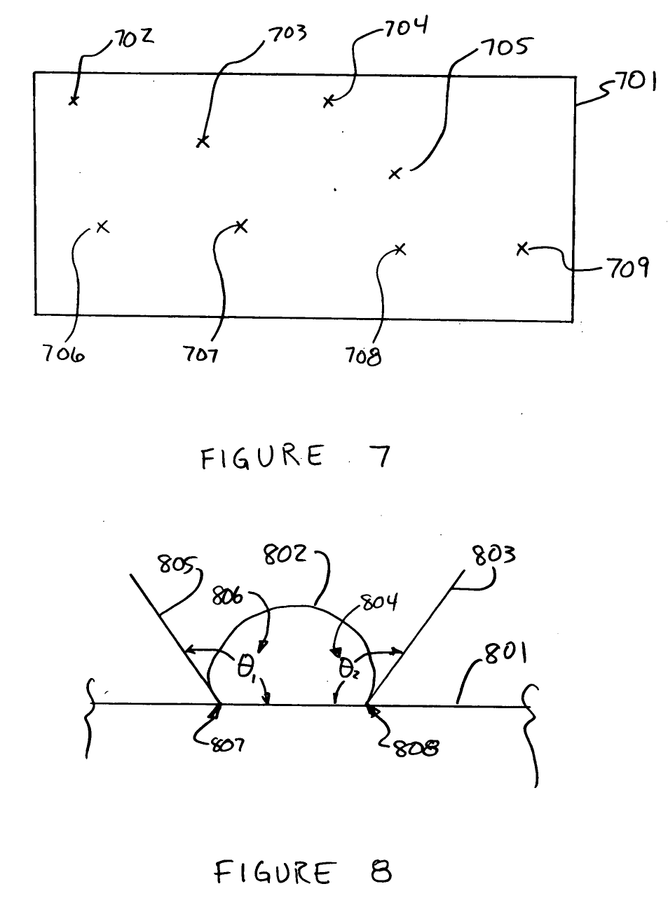

As seen in FIG. 7, the substrate 701 has a variety of arbitrary positions 702, 703, 704, 705, 706, 707, 708, 709 across its surface. The contact angle measurements at the positions 702, 703, 704, 705, 706, 707, 708, 709 are consistent with each other within +/−3 degree in some embodiments of the present invention after significant exposure to moisture.

In some embodiments of the present invention, as shown in FIG. 8, the substrate 801 has a droplet 802 on its surface for the purpose of measuring the contact angle. The contact angle 804 measuring the angle of the tangent line 803 at the point 808 is consistent with the contact angle 806 measuring the angle of the tangent line 805 at the point 807 to with +/−3 degree in some embodiments. The contact angle 806 is consistent with other contact angles around the meniscus of drop 802 to within +/−3 degrees in some embodiments of the present invention.

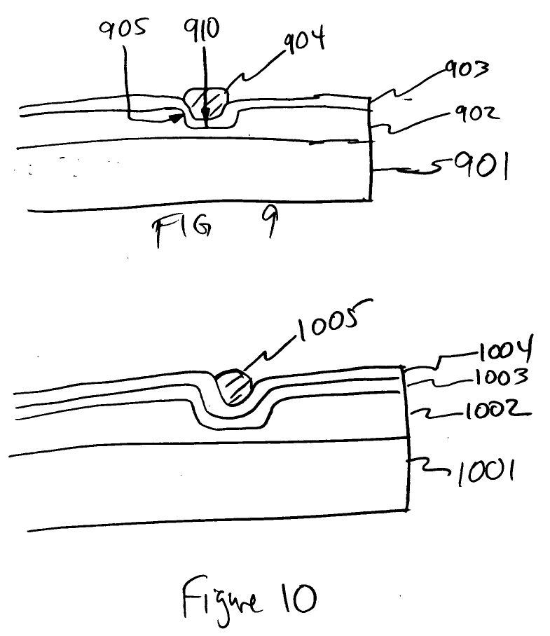

In some embodiments of the present invention, as seen in FIG. 9, substrate 901 has undergone further processing. In some embodiments substrate 901 is a silicon substrate. Dielectric layer 902 sits upon silicon substrate 901 in this embodiment. In some embodiments, dielectric layer 902 may be sitting upon other layers that have been deposited upon the substrate. Silane layer 903 is deposited upon dielectric layer 902, and is used as a diffusion barrier layer in some embodiments. When copper portion 904 is deposited upon silane layer 903, silane layer 903 presents a diffusion barrier between copper portion 904 and dielectric layer 902 for example in the area of the layers' adjacency 905. When deposited according to some embodiments of this invention, silane layer 903 is relatively defect free and is an improved diffusion barrier layer. In prior art methods diffusion barrier layers were significantly thicker. For example, a tantalum layer may be used and be 200 angstroms thick. Using an example of a trench 905 that is 1000 angstroms wide to start, the prior art barrier layers would then narrow the trench by 400 angstroms, allowing only 600 angstroms width of copper despite the 1000 angstrom starting width. According to some embodiments of the present invention, the silane layer 903 may be significantly thinner. The silane layer 903 may, for example, be 5, 10, 15, 20 or more angstroms thick. When the silane layer 903 is formed using different process parameters, such as increased process time, the layer will self-assemble and become thicker. The controlled thickness of the silane layer 903, and the use of a thin silane layer 903, provide benefit in this and other applications.

In some embodiments of the present invention, as seen in FIG. 10, substrate 1001 has undergone further processing. In some embodiments substrate 1001 is a silicon substrate. Dielectric layer 1002 sits upon silicon substrate 1001 in this embodiment. Silane layer 1003 is deposited upon dielectric layer 1002. Silane layer 1104 is deposited upon silane layer 1003. Silane layer 1003 and silane layer 1004 are the same type of silane in some embodiments. Silane layer 1003 and silane layer 1004 are different types of silane in some embodiments.

A process for the coating of substrates in a process chamber, which may include dehydrating the substrate, and vaporizing the chemical to be reacted prior to its entry into the process chamber. Among the benefits of this invention are the enhancement of the repeatability of the process product and the reduction of risks associated with processing.

A substrate for the chemical deposition of different chemicals may be of any of a variety of materials. For biotech applications, a glass substrate, or slide, is often used. Glass substrates may be borosilicate glass, soda lime glass, pure silica, or other types. In some semi-conductor applications, the substrate may be silicon with other layers including dielectrics layers already processed. Substrate dehydration may be performed as part of some processes. The substrate is inserted into the process chamber. The substrate is then dehydrated. Residual moisture interferes with the adhesion of chemicals during the deposition process. Alternatively, dehydration of the substrate allows for later rehydration in a controlled fashion. The dehydration process alternates exposing the substrate to vacuum and then to heated nitrogen, either once or multiple times. For example, the substrate would be exposed to a vacuum of 10 Torr for 2 minutes. At this pressure water boils at about 11 C. The vacuum chamber would then be flooded with preheated nitrogen at 150 C. This part of the process would heat the surface of the substrate so that the high temperature of the slide would assist in the dehydration process as vacuum was once again applied. After 3 complete cycles, a vacuum of 1 Torr would be applied to complete the dehydration process.

After the completion of the dehydration cycle, the substrate is ready for chemical reaction. Chemical reservoirs, such as manufacturer's source bottles, provide the chemical for the deposition process. For many processes, silanes are used. Among the silanes used are amino silanes, epoxy silanes, and mercapto silanes. Chemical may be withdrawn directly from the reservoir. A metered amount of chemical is withdrawn from the chemical reservoir. This may be done by opening a valve between the chemical reservoir and a withdrawal mechanism. The withdrawal mechanism may be a syringe pump. Chemical is withdrawn from the reservoir, enters the syringe pump, and then the valve between the chemical reservoir and the syringe pump is closed. The chemical reservoirs may be purged with an inert gas such as nitrogen. This purging allows for the filling of the volume of fluid removed with an inert gas, minimizing contact between the chemical in the reservoir and any air or moisture.

Next, a valve between the syringe pump and a vaporization chamber is opened. The vapor chamber may be pre-heated. The vapor chamber may be at reduced pressure. The syringe pump then pumps the previously withdrawn chemical from the syringe pump to the vaporization chamber. The vapor chamber may be at the same vacuum level as the process oven. In parallel to this delivery of chemical to the vaporization chamber, a second chemical may be undergoing the same delivery process. The two chemicals may vaporize at substantially the same time. Additionally, more chemicals may also be delivered to the vaporization chamber, or to another vaporization chamber.

The reduced pressure in the vapor chamber, and/or the elevated temperature in the vapor chamber may allow for the vaporization of chemicals at pre-determined pressure levels and temperatures.

The vaporized chemical, or chemicals, are then delivered to the process chamber. This may be done by opening a valve between the vaporization chamber and the process oven after the chemical has vaporized in the vaporization chamber. Alternatively, the valve between the vaporization chamber and the process oven may already be open when the chemical, or chemicals, are delivered to the vaporization chamber. The chemical then proceeds into the process chamber and reacts with the substrate.

In one example, a process for the creation of a layer of 3-Glycidoxypropyl-trimethoxysilane on a substrate of glass. The above mentioned silane is provided in a 98% solution. After dehydration of the slide, the silane is routed to the vapor chamber. In this example, 5 ml of this silane is provided to a vapor chamber which has been pre-heated to 150 C. and has a pressure of approximately 5 Torr. The valve between the vapor chamber and the process oven is open during this example of the process. The process duration after the injection of the silane into the vapor chamber is 2 minutes in this example.

In another example, a process for the creation of a layer of 3-Glycidoxypropyl-trimethoxysilane on a substrate of glass. The above mentioned silane is provided in a 98% solution. After dehydration of the slide, the silane is routed to the vapor chamber. In this example, 10 ml of this silane is provided to a vapor chamber which has been pre-heated to 190 C. and has a pressure of approximately 10 Torr. The valve between the vapor chamber and the process oven is open during this example of the process. The process duration after the injection of the silane into the vapor chamber is 2 minutes in this example.

In another example, a process for the creation of a layer of 3-Glycidoxypropyl-trimethoxysilane on a substrate of glass. The above mentioned silane is provided in a 98% solution. After dehydration of the slide, the silane is routed to the vapor chamber. In this example, 10 ml of this silane is provided to a vapor chamber which has been pre-heated to 190 C. and has a pressure of approximately 16 Torr. The valve between the vapor chamber and the process oven is open during this example of the process. The process duration after the injection of the silane into the vapor chamber is 10 minutes in this example.

In another example, a process for the creation of a layer of 3-aminopropyltrimethoxysilane on a substrate of glass. The above mentioned silane is provided in a 97% solution. After dehydration of the slide, the silane is routed to the vapor chamber. In this example, 2 ml of this silane is provided to a vapor chamber which has been pre-heated to 100 C. and has a pressure of approximately 3.5 Torr. The valve between the vapor chamber and the process oven is open during this example of the process. The process duration after the injection of the silane into the vapor chamber is 20 minutes in this example.

In another example, a process for the creation of a layer of 3-aminopropyltrimethoxysilane on a substrate of glass. The above mentioned silane is provided in a 97% solution. After dehydration of the slide, the silane is routed to the vapor chamber. In this example, 5 ml of this silane is provided to a vapor chamber which has been pre-heated to 90 C. and has a pressure of approximately 6.5 Torr. The valve between the vapor chamber and the process oven is open during this example of the process. The process duration after the injection of the silane into the vapor chamber is 20 minutes in this example.

In another example, a process for the creation of a layer of 3-aminopropyltrimethoxysilane on a substrate of glass. The above mentioned silane is provided in a 97% solution. After dehydration of the slide, the silane is routed to the vapor chamber. In this example, 10 ml of this silane is provided to a vapor chamber which has been pre-heated to 150 C. and has a pressure of approximately 16 Torr. The valve between the vapor chamber and the process oven is open during this example of the process. The process duration after the injection of the silane into the vapor chamber is 20 minutes in this example.

In another example, a process for the creation of a layer of 3-aminopropyltriethoxysilane on a substrate of glass. The above mentioned silane is provided in a 99% solution. After dehydration of the slide, the silane is routed to the vapor chamber. In this example, 5 ml of this silane is provided to a vapor chamber which has been pre-heated to 90 C. and has a pressure of approximately 2.75 Torr. The valve between the vapor chamber and the process oven is open during this example of the process. The process duration after the injection of the silane into the vapor chamber is 20 minutes in this example.

In another example, a process for the creation of a layer of 3-aminopropyltriethoxysilane on a substrate of glass. The above mentioned silane is provided in a 99% solution. After dehydration of the slide, the silane is routed to the vapor chamber. In this example, 10 ml of this silane is provided to a vapor chamber which has been pre-heated to 150 C. and has a pressure of approximately 11.5 Torr. The valve between the vapor chamber and the process oven is open during this example of the process. The process duration after the injection of the silane into the vapor chamber is 10 minutes in this example.

In another example, a process for the creation of a layer of 3-aminopropyltriethoxysilane on a substrate of glass. The above mentioned silane is provided in a 99% solution. After dehydration of the slide, the silane is routed to the vapor chamber. In this example, 10 ml of this silane is provided to a vapor chamber which has been pre-heated to 150 C. and has a pressure of approximately 9 Torr. The valve between the vapor chamber and the process oven is open during this example of the process. The process duration after the injection of the silane into the vapor chamber is 5 minutes in this example.

In another example, a process for the creation of a layer of 3-aminopropyltriethoxysilane on a substrate of glass. The above mentioned silane is provided in a 99% solution. After dehydration of the slide, the silane is routed to the vapor chamber. In this example, 10 ml of this silane is provided to a vapor chamber which has been pre-heated to 150 C. and has a pressure of approximately 9 Torr. The valve between the vapor chamber and the process oven is open during this example of the process. The process duration after the injection of the silane into the vapor chamber is 2 minutes in this example.

Silanes which may be used in processes according to embodiments of this invention include 3-aminopropyltriethoxysilane, 3-aminopropyltrimethoxysilane, decyltriethoxysilane, 4-triethoxysilylbutyronitile, 3-triethoxysilylpropylmetacralate, triethoxysilylbutyraldehyde, 10-undecenyltrichlorosilane, dodecyltrichlorosilane, isocyanatopropyltriethoxysilane, and other chemicals. Silanes which may be used in processes according to embodiments of this invention include mercapto, epoxy, and amino silanes.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

1. A coated substrate comprising:
a substrate; and
a silane layer,
wherein said silane layer has a consistent surface energy with a contact angle consistency within +/−8 degrees across its surface after significant exposure to moisture.

2. A coated substrate comprising:
a substrate, wherein said substrate comprises a dielectric layer, and
a silane layer, wherein said silane layer has a consistent surface energy across its surface, and wherein said silane layer has a consistent thickness.

3. The coated substrate of claim 1 wherein said silane layer has a consistent surface energy with a contact angle consistency within +/−6 degrees.

4. The coated substrate of claim 1 wherein said silane layer has a consistent surface energy with a contact angle consistency within +/−4 degrees.

5. The coated substrate of claim 1 wherein said silane layer has a consistent surface energy with a contact angle consistency within +/−3 degrees.

6. The coated substrate of claim 5 wherein said substrate comprises glass.

7. The coated substrate of claim 1 wherein said substrate comprises a dielectric layer.

8. The coated substrate of claim 5 wherein said silane comprises 3-aminopropyltrimethoxysilane.

9. The coated substrate of claim 5 wherein said silane comprises 3-glydioxypropyl-trimethoxysilane.

10. A process for coating of substrates comprising:
inserting a substrate into a process chamber;
dehydrating said substrate;
supplying a first chemical to a heated vaporization chamber;
vaporizing said first chemical; and
supplying the vapor of said first chemical to a process chamber, thereby coating said substrate.

11. The process of claim 10 wherein said first chemical is 3-aminopropyltriethoxysilane.

12. The process of claim 10 wherein said first chemical is 3-aminopropyltrimethoxysilane.

13. The process of claim 10 wherein said first chemical is decyltriethoxysilane.

14. The process of claim 10 wherein said first chemical is isocyanato propyltirethoxysilane.

15. The process of claim 10 wherein said first chemical is dodecyltrichlorosilane.

16. The process of claim 10 wherein said first chemical is 10-undecenyltrichlorosilane.

17. The process of claim 10 wherein said substrate comprises a dielectric layer.

18. The process of claim 17, wherein said process further comprises:
supplying a first chemical to a heated vaporization chamber in a second instance;
vaporizing said first chemical in a second instance; and
supplying the vapor of said first chemical to a process chamber in a second instance, thereby applying an additional coating to said substrate.

19. The process of claim 17, wherein said process further comprises:
supplying a second chemical to a heated vaporization chamber;
vaporizing said second chemical; and
supplying the vapor of said second chemical to a process chamber, thereby coating said substrate.
